(19) United States
(12) Patent Application Publication
(10) Pub. No.: US 2010/0082915 A1
(43) Pub. Date: Apr. 1, 2010

(54) Method and system for accessing storage via the internet

(76) Inventor: Shi-Ming Zhao, Jhudong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,711

(22) Filed: Sep. 23, 2009

Related U.S. Application Data
(60) Provisional application No. 61/100,270, filed on Sep. 26, 2008.

(51) Int. Cl. G06F 12/00; G06F 12/02

(52) U.S. Cl. 711/154; 711/170; 711/E12.001; 711/E12.002

(57) ABSTRACT

Embodiments of the present invention set forth methods and systems for accessing storage via the Internet. Specifically, one embodiment of the present invention sets forth a method, which includes the steps of automatically establishing a connection to the Internet, automatically logging into a first account and a second account, wherein first storage space is allocated to the first account and second storage space is allocated to the second account, aggregating the first storage space and the second storage space to formulate an aggregated storage space, and mapping the aggregated storage space into a set of contiguous memory locations.

### REFERENCE TO RELATED APPLICATION

This Application is based on Provisional Patent Application Ser. No. 61/100,270, filed Sept. 26, 2008, currently pending.

### BACKGROUND OF THE INVENTION

1. Field of the Invention

Embodiments of the present invention relate generally to storage technologies and more specifically to a method and system for accessing storage via the Internet.

2. Description of the Related Art

Unless otherwise indicated herein, the approaches described in this section are not prior art to the claims in this application and are not admitted to be prior art by inclusion in this section.

Instead of keeping information in and accessing information from a storage device at a fixed location, it is becoming increasingly prevalent to store and access information via the Internet. Many online service offerings not only make available free and sizable storage space to their subscribers, but also provide the subscribers with tools to manage such storage space. For example, Microsoft offers a password- protected online file storage service, Windows Live™ SkyDrivea, to any computer with Internet access. After signing up such a service, the amount of the storage space allocated to the account is generally limited to a fixed amount, such as 5 GB. Thus, if more than 5 GB of storage space is desired, then one common approach is to create and register multiple unique accounts. However, each unique account requires a separate login process. Also, moving data from one unique account to another cannot be accomplished in a straight forward drag-and-drop manner currently.

As the foregoing illustrates, what is needed is thus an improved mechanism to access storage via the Internet and address at least the problems discussed above.

### SUMMARY OF THE INVENTION

Embodiments of the present invention set forth methods and systems for accessing storage via the Internet. Specifically, one embodiment of the present invention sets forth a method, which includes the steps of:

(a) automatically establishing a connection to the Internet;

(b) automatically logging into a first account and a second account, wherein first storage space is allocated to the first account and second storage space is allocated to the second account;

(c) aggregating the first storage space and the second storage space to formulate an aggregated storage space; and

(d) mapping the aggregated storage space into a set of contiguous memory locations.

According to the present invention, wherein the step (a) illustrates a pen driver capable of connecting to a target device, wherein the pen drive configured with an Internet Space Management Program which further comprising a network connection component, an auto-run component, an auto-login component and a storage management component.

And the first storage space and the second storage space further comprise a network remote host.

### BRIEF DESCRIPTION OF THE DRAWINGS

The accomplishment of this and other objects of the invention will become apparent from the following descriptions and its accompanying figures of which:

FIG. 1 is a flow chart illustrating a process that the method for accessing storage;

FIG. 2 is a conceptual diagram of a pen drive configured to implement one or more aspects of the present invention; and

FIG. 3 is a flow chart illustrating a process that a pen drive is configured to follow.

### DETAILED DESCRIPTION OF THE PREFERRED EMBODIMENT

The background information and the technical details set forth enable a person skilled in the art to implement one embodiment of the present invention to guard against the spreading of malware. A simplified block diagram of a pen drive configured to perform one or more aspects of the present invention is also illustrated. One embodiment of the present invention includes, among other things, at least the following features and functionalities:

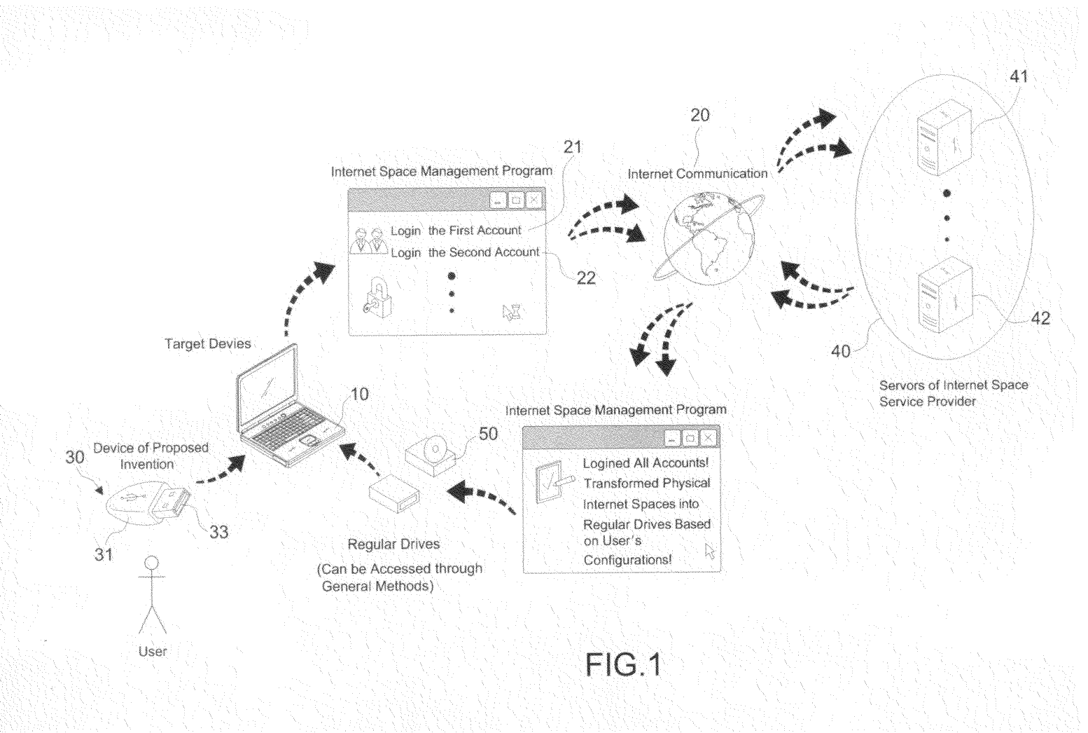

According to one embodiment of the present invention, FIG. 1 is a flow chart illustrating a process that the method for accessing storage via the Internet. Referring to FIG. 1˜3, a pen drive 30 connects to a target device 10, such as a computer, wherein the pen drive 30:

(a) automatically establishing a connection to the Internet 20;

(b) automatically logging into a first account 21 and a second account 22, wherein first storage space 41 is allocated to the first account 21 and second storage space 42 is allocated to the second account 22;

(c) aggregating the first storage space 41 and the second storage space 42, or more storage spaces (not shown) to formulate an aggregated storage space 40; and

(d) mapping the aggregated storage space into a set of contiguous memory locations.

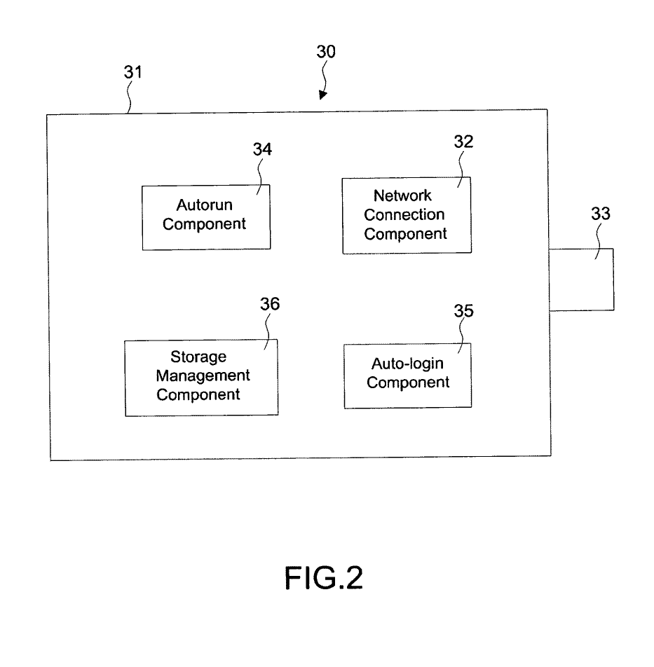

According to one embodiment of the present invention, FIG. 2 illustrates a pen drive 30 capable of connecting to a target device 10. In one implementation, the communication between the pen drive 30 and the target device 10 adheres to the USB standard 33. The pen drive 30 comprises a case 31, wherein the case 31 being configured with an Internet Space Management Program. The Internet Space Management Program is configured with an auto-run component 34, a storage management component 36, a network connection component 32, and an auto-login component 35.

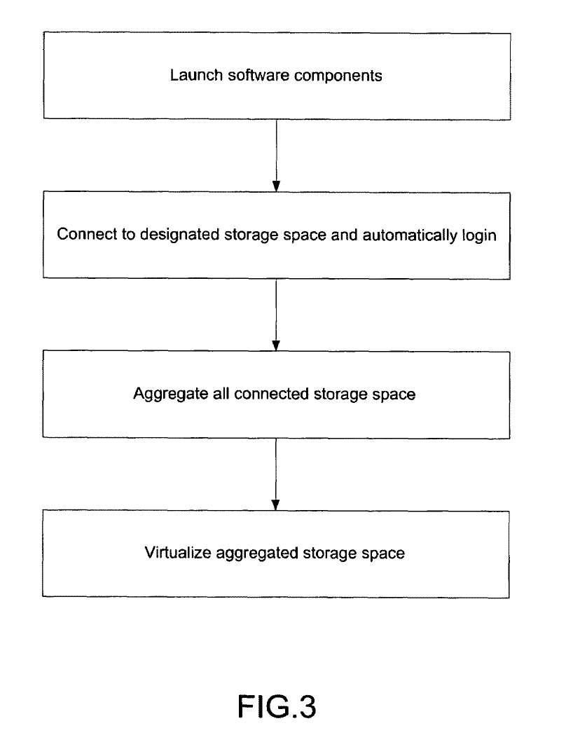

According to one embodiment of the present invention, FIG. 3 is a flow chart illustrating a process that a pen drive is configured to follow. Specifically, upon establishing the connection between the pen drive 30 and a target device 10, various software components, such as the ones shown in FIG. 2, are installed on the target device 10 as the instructions for the auto-run component 34 are executed. The instructions for the network connection component 32 are also executed, so that the needed network stack (e.g., TCP/IP stack) is established on the target device 10, and the communication session between the target device 10 and the Internet 20 is initiated. The instructions for the auto-login component 35 are then executed to enable the target device 10 to login to a pre-determined set of accounts online and connect the target device 10 to the storage space associated with the accounts. The instructions for the storage management component 36 are then executed to aggregate the storage space associated with the pre determined set of accounts and also virtualize the aggregated storage space 40.

Based upon the above-mentioned configuration, the invention further comprises to transform physical internet spaces into regular drives 50 bases on user's configurations. The regular drives 50 could also be a CD-ROM, a hard discs, etc.

While the forgoing is directed to embodiments of the present invention, other and further embodiments of the present invention may be devised without departing from the basic scope thereof, and the scope thereof is determined by the claim that follow.

What is claimed is:

1. A method for accessing storage via the Internet, comprising:
(a) automatically establishing a connection to the Internet;
(b) automatically logging into a first account and a second account, wherein first storage space is allocated to the first account and second storage space is allocated to the second account;
(c) aggregating the first storage space and the second storage space to formulate an aggregated storage space; and
(d) mapping the aggregated storage space into a set of contiguous memory locations.

2. The method of claim 1, wherein the step (a) illustrates a pen drive capable of connecting to a target device, wherein the pen drive configured with an Internet Space Management Program which further comprising a network connection component, an auto-run component, an auto-login component and a storage management component.

3. The method of claim 3, wherein the step (b) further comprises to login to a pre-determined set of accounts online and connect the target device to the storage space associated with the accounts after the auto-login component executed.

4. The method of claim 2, wherein the first storage space and the second storage space further comprise a network remote host.

5. The method of claim 3, wherein the step (c) further comprises to execute the storage management component to aggregate the storage space associated with the predetermined set of accounts and also virtualize the aggregated storage space.

6. The method of claim 2, wherein the step (d) further comprises to transform physical internet spaces into regular drives bases on user's configurations.
